(19) United States
(12) Patent Application Publication
(10) Pub. No.: US 2019/0329506 A1
(43) Pub. Date: Oct. 31, 2019

(54) METHOD OF LAYERED LAMINATION OF A CONSTRUCTIONAL ELEMENT WITH A UNIFORM AND/OR HYBRID FIBRE-POLYMER COMPOSITE IN AN IN-SITU METHOD BY THE USE OF ULTRASONIC VIBRATION IN A CONTINUOUS PROCESS AND A DEVICE FOR THE REALIZATION OF THE METHOD

(71) Applicant: CAVICO sp. Z o.o., Poznan (PL)

(72) Inventors: Piotr Edward WELTER, Poznan (PL); Ryszard PELC, Poznan (PL)

(21) Appl. No.: 16/349,978

(22) PCT Filed: Nov. 14, 2017
(86) PCT No.: PCT/IB2017/057094

§ 371 Date: May 14, 2019

(30) Foreign Application Priority Data
Nov. 15, 2016 (PL) PL419471

(51) Int. Cl. B29C 70/30; B29C 70/54

(52) U.S. Cl. CPC B29C 70/30; B29C 70/54

(57) ABSTRACT

The method of manufacturing of a layered composite laminate for use as a reinforcement of a constructional element includes application of layered composite laminate on the treated constructional element in situ in a continuous process by the use of ultrasonic vibration. The constructional element is put in a feed motion and next it is subjected to the process of layered composite lamination including at least three stages: shuffling stage, sonication stage, and crosslinking stage. Subject matter of the invention includes a device for the realization of that method.

### CROSS-REFERENCE TO RELATED APPLICATIONS

See also Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

A method of layered lamination of a constructional element with an uniform and/or hybrid fibre-polymer composite in an in-situ method by the use of ultrasonic vibration in a continuous process and a device for the realization of the method

Subject matter of the invention is a method of reinforcing and/or lamination of a constructional element with an uniform and/or hybrid fibre-polymer composite in an in-situ method by the use of ultrasonic vibration in a continuous process using streaks of fibre-material as tendon-roving and/or fabric-composite mat in supporting constructional elements like floor beams, bridge beams and roof beams, especially with the designation for construction industry. A further subject matter of the invention is a device enabling an application of layered composite laminate on a surface and/or a place of a treated constructional element.

The apparatus enables manufacturing of narrow constant and/or variable cross section on a narrower surface of the constructional element, hereinafter called Sonotrusion by means of a fibre material, that are especially applied in the places of a constructional element, where tensile forces act. A reinforcement of broad cross section can be applied on a broad surface of the constructional element hereinafter called Sonolamination by means of series-parallel arranged fibre material in a form of tendon-roving and/or fabric-composite mat one-, two- and/or multidirectional. They are especially used in reinforcing broad planes on which tensile forces act and/or in reinforcing and/or layered connecting e.g. layer reinforcing of constructional boards for the purpose of connecting them in the width.

### 2. Description of Related Art Including Information Disclosed Under 37 CFR 1.97 and 37 CFR 1.98.

The hitherto state of the art in the area of fibre-based polymer composites comprises of: pulltrusion, being one of the oldest means of manufacturing synthetic materials reinforced with fibre thermoplastic materials, very sensitive to temperature. By means of pulltrusion reinforcements for the purpose of strengthening are made, most commonly through sticking in earlier made rods and/or other profiles by the method of pulling. Mainly due to their low thermal resistance they aren't applied in construction industry. Another method of reinforcing elements or their manufacture is the newest until now technology based on pre-pregs. These are soaked with polymer matrix rovings and/or composite fabrics of different weave, stored in low temperatures for the purpose of considerable deceleration of the crosslinking-hardening reaction of polymer. In order to obtain any product from pre-pregs, they are laid out into forms which are hardened through a press and/or pressure with the use of slightly increased temperature for the acceleration of the crosslinking process. In both cases: the pulltrusion and the production of pre-preg, an energy-consuming manufacturing process is used, which as a result gives only an intermediate product for further processing. There is also a number of other methods being limited because of the manufacturing process and often requiring the use of a form i.e. hand lay-up method, elastic stamp pressing method, RTM (resin transfer moulding) method, or filament winding method. Currently is the endurance of the hitherto composites a problem, because air bubbles contained in the mass of polymer matrix weaken the whole construction of a composite. This problem occurs in all manufacturing methods except for the methods using vacuum and/or pressure e.t. autoclaves, or RTM the latter requires, however, a special method and a process limited to the use of a constant form dedicated for one element. Moreover these methods do not enable in a continuous process: to freely make use of significant properties and role of modern highly-reactive resin hardening agents, to improve the properties of the composite by adding nanomaterials and/or to obtain high temperature resistance of a polymer composite (above 80° C.) in order to use them in the construction industry, which ensues i.a. form the norms of construction law. None of the hitherto technologies of manufacturing polymer composites from fibre materials enables the creation of a laminate or a reinforcement of a variable cross section in a continuous process.

A use of a sonotrode is also known. It is known, that ultrasonic sonotrodes are used for connections, cutting, punching, printing or treating with heat.

From the description US2012276236 known is a device for the treatment of a material web through an ultrasonic unit, whereas the web material is guided through a gap between the sonotrode and the counter tool and affects the sonotrode, whereas the ultrasonic unit is adjustable relative to the counter tool by way of a movable carriage, moreover the booster is firmly connected to the carriage.

### BRIEF SUMMARY OF THE INVENTION

The method according to the subject matter of the invention concerns the method of manufacturing layered composite laminate applied on a surface and/or on a place, which was earlier treated by milling, of the treated constructional element. The process takes place in situ in a continuous process with the use of ultrasounds.

The essence of the invention is the method of manufacturing layered composite laminate for use as reinforcement of constructional elements, characterised in that the application of the layered composite laminate on the surface and/or the place of the treated constructional element happens in situ in a continuous process with the use of ultrasounds; the initially prepared constructional element is put in a feed motion and next it is subjected to the process of layered composite lamination comprising of at least three stages:

a) shuffling stage, where to a shuffling head in front of at least one shuffling element, simultaneously fibre materials (roving materials) and/or additional fibre materials are conveyed from bobbin creel and to the interior of each shuffling element via inflow opening a polymer matrix is conveyed through ducts in a one-, two- or multicomponent system from a container by means of a pump of a total output in weight relation to the fibre material from 0.8:1 to 1.2:1; as a result of shoving the constructional element the fibre material being sandwiched and simultaneously soaked with polymer matrix, passing through the shuffling head that is sliding over the constructional element the fibre material is laid on the surface and/or in the place of the constructional element;

b) sonication stage, where by means of a sonotrode of a width of at least equal to the width of the applied laminate and of a power from 5 to 500 W/cm² pressing and mixing of all the components of polymer matrix takes place in a time from 2 to 10 sec, through sliding of the sonotrode at the place of the earlier layered laid fibre material soaked with polymer matrix on the constructional element;

c) crosslinking stage during which the layered laid fibre material soaked with polymer matrix and being on the constructional element after the sonication stage is submitted to thermal treatment of hardening in an oven, in a temperature range from 50 to 180° C.; to the moment of reaching the desired level of hardening and maximum thermal resistance from 2 to 6 hrs;

Favourably the constructional elements are beams, glulam, wood-base boards, boards from wood or synthetic materials, lignocellulosic boards initially prepared through caving of the material.

Favourably the multi-layered composite laminate is a hybrid system, consisting of fibre materials conveyed to the shuffling head from the bobbin creel; whereupon the fibre materials are used in the form of roving or roving-fabrics from natural, cellulosic and/or synthetic i.e. carbon, basalt, glass, aramid fibres; whereupon the roving fabrics appear in an one-, two- or multidirectional system.

Favourably in the method according to the invention additionally through the shuffling elements, at least two streaks of fibre material are interleaved, making up a convergent angle in that through a conveying-and-cutting apparatus an additional fibre material in the form of continuous roving and/or in sections is inserted and subsequently grabbed; whereupon the obtained layered composite laminate has a constant and/or variable cross section.

Favourably the shuffling stage and the sonication stage occur one and/or many times and the crosslinking stage is always the last one.

Favourably the polymer matrix contains additives and/or fillers in micro- or nanoscale in the form of powders and/or suspensions refining the polymer matrix such as nanographite, graphene flakes, carbon nanotubes, nanoclay, grinded roving.

Favourably at the crosslinking stage during the thermal treatment continuous ovens, non-continuous ovens, covering the laminate with heating panel and/or laying heating bars is(are) used.

Further subject matter of the invention is a device for application of polymer matrix on fibre material and preparation of layered laminate and/or composite reinforcement for laying on the surface of a treated constructional element and/or in a place prepared for that characterised in that it consists of at least two longitudinal, external housing elements connected to each other with screws through straightway mounting openings, the length of the housing elements being dependant on the spacing and the number of shuffling elements with the allowance of a bed at the length of a sonotrode constituting the sliding construction of the shuffling head and these housing elements have: straightway mounting openings, at the initial part an opening for mounting at a moveable joint, whereupon at least one housing element has inflow openings in a number equal to the number of the shuffling elements; between the housing elements internal spacers are located leading the head and having straightway mounting openings of a length dependent on the spacing and the number of shuffling elements, whereupon at least one of the spacers has inflow openings in a number equal to the number of shuffling elements; between the spacers one and/or more streamlined shuffling elements are located through tangential surfaces of which the fibre material is drawn, the shuffling elements are arranged lengthwise to each other serial and/or parallel having on the flat side surface straightway mounting openings and an inflow opening in its central axis, where the polymer matrix is conveyed and an—reaching the inside of the inflow opening—outflow opening on the tangential plane at the lower part of the element, where the polymer matrix outflows on the fibre material; the shuffling head in the terminal part between the housing elements has a spacer block with a hanger and with straightway mounting openings.

Favourably the straightway mounting openings of individual elements of the shuffling head are situated one to another coaxial-concentric, moreover the inflow openings of the housing element and the internal spacers are, at least geometrically inscribed in individual inflow openings of the shuffling elements.

Favourably the inflow opening in the shuffling element is directed towards the fibre material and is situated on the tangential surface at an angle in respect of the horizontal axis of the shuffling head in a range from 0° to −135°

Favourably the curvature radius of the shuffling element in the place tangential with the fibre material is bigger or equal to 16 mm, favourably 20 mm.

Favourably through subtraction or multiplication of the number of shuffling elements in a serial and/or parallel system the adjustment of the width of the shuffling head takes place.

Favourably the internal spacer is protruding under the level of the lower edge of the housing element in a range from 0% to 70% of the depth of the caved material, favourably by 8 mm.

The method of manufacturing layered composite laminate according to the invention consists of: a drive line, a hanger so called bobbin creel for a fibre material (roving material), at least one multistream pump, at least one container for polymer matrix, a shuffling head, sonotrode, heating element in the role of a warming oven. In the manufacturing method three main process stages are distinguished: shuffling stage, sonication stage, crosslinking stage. In a favourable example of realization enabling the manufacturing of composite laminate of variable cross section additionally conveying-and-cutting device are used.

A constructional element led by transport rollers is put into motion through a drive. The constructional element is driven under the shuffling head the housing of that is sliding on the surface of the constructional element. Thanks to that a very big efficiency in a continuous process of application of the laminate-reinforcement is obtained, what is solely dependent on the feed speed of the constructional element and the output of the pump dosing polymer matrix. The shuffling head is equipped with internal spacers stabilizing the sliding movement and simplifying the application of the fibre material and the polymer matrix through directing on a place of application. Between the internal spacers are shuffling elements spread lengthwise the shuffling head. At their tangential surfaces uniform or hybrid fibre material conveyed from bobbin creel is interleaved. It is possible to insert an additional fibre material between the fibre material through an conveying-and-cutting apparatus thus creating a fibre reinforcement of variable cross section. To the interior of each of the shuffling elements a fluid polymer matrix is conveyed through ducts, from at least one container with the use of a multistream pump of favourable output in relation to the conveyed fibre material. The conveyed polymer matrix is in a one-, two-, and/or multicomponent system using a plurality of shuffling elements and their inflow openings and outflow openings directed towards the constructional element and the fibre material. Through the shuffling head the fibre material is sandwiched interchangeably with polymer matrix and/or their respective components. The conveying of the polymer matrix to each shuffling head separately enables:
an application of an one-, two- and/or multicomponent polymer composition, which results in the application universality of the resins, hardening agents and/or accelerating agents used,
with an initial mixing in a container enables adding fillers, micro- and nonoadditives to freely chosen layers of the reinforcing laminate,
using e.g. the first shuffling element for grounding of the constructional element's surface, another polymer matrix can be used (in such a case two different containers shall be used) than the matrix conveyed on the fibre material e.g. a matrix with nanoadditives of a far lower viscosity, which will connect the layers of the reinforcement more favourably.

After the shuffing stage, a fibre material soaked with polymer matrix is obtained, which is laid on the constructional element, afterwards the sonication stage takes place, where the shifted constructional elements moves under the sonotrode. The width of the sonotrode is adjusted to the width of the shuffling head and to the width of the laminate being laid. The sonotrode is seated in the prolongation of the housing elements in the bed of the shuffling head. The shifted constructional element lifts the sonotrode which comes over the fibre material that has been laid and slides over it. Under the influence of ultrasonic vibrations and the own mass of the sonotrode mixing of the polymer matrix components and pressing of the composite laminate takes place.

Configuration of the sonication time is possible through adjustment of the feed speed of the constructional element and/or the choice of the length of the sonotrode in relation to the feed speed. After the sonication stage, the crosslinking stage takes place, where the composite laminate and/or the whole constructional element is subjected to thermal treatment. During this stage the crosslinking process of the polymer matrix takes place with the use of a heating oven and/or a heating element. The warming time and the range of temperatures of the crosslinking process are dependent on the sort of the polymer matrix mixture. The crosslinking process usually is contained within a temperature range from 50 to 180° C. and a time from 2 to 6 hrs for reaching the desired level of hardening and giving the maximum thermal resistance (for high-temperature polymer matrices).

In the manufacturing method of the layered composite laminate for reinforcing, constructional supporting elements are used such as beams, glulam, wood-base boards, boards from wood or synthetic materials, lignocellulosic boards and/or other boards and composite materials.

A characteristic feature of the manufacturing method is the freedom of choice of the composition of the fibre material that is sandwiched in the shuffling head, which enables the use of an uniform and/or hybrid composition. In the manufacturing method for reinforcement of the constructional element fibre materials in the basic form of a tendon (roving) and/or roving fabrics are used. The fibre material are hanged on a roving hanger, so called bobbin creel and conveyed to the shuffling head, where they are further laid on the constructional element. The fibre material are made of natural, cellulosic and/or synthetic i.e. carbon, basalt, glass, aramid and other fibres used in the composites industry. Moreover the roving fabrics appear in a one-directional (unidirectional) i.e. in uniaxial, two-directional (i.e. biaxial) and/or multidirectional (multiaxial) e.g. 3-axial, 4-axial as well as in an uniform and/or hybrid system. Thanks to that an economical design of the reinforcement of the constructional element is possible for a given length (for a suitable endurance) and in the direction of an individual use (obtaining the resistance of the composite for the influence of various agents, i.e. temperature, chemicals, moisture, sun radiation, insects).

Also typical of the method of manufacturing is the staging or the process in which the shuffling stage (A) and sonication stage (B) occur one or many times, and the last one is always the crosslinking stage (C). The one-time occurrence takes the scheme of a given formula: A+B+C. The many times occurrence takes the scheme of a given formula: (A+B)₁+(A+B)₂+ . . . (A+B)ₙ+C, where n=natural numbers. The multiplicity of the shuffling stage (A) and the sonication stage (B) is especially advisable when manufacturing lamination with significantly increased cross section, where the number of the layers laid influences the thickness of the laminate, which influences positively the effectiveness of the ultrasonic sonication process.

During the sonication stage by means of ultrasonic vibrations of the sonotrode and with advantageous power, amplitude and the frequency of the vibrations in a relatively short time simultaneously and homogenously takes place the soaking of the fibre material with the polymer matrix, densification of the fibre material, mixing of the components of the polymer matrix and the matrix's degassing through the removal of air bubbles, deeper penetration of the polymer matrix into the porous structures of the constructional element. One has to remember that all the above mentioned processes take place in the material and in a continuous process. The polymer matrix for the improvement of physic-mechanical properties may conatin additives and/or fillers in micro- or nanoscale in the form of powders and/or suspensions refining the polymer matrix such as nanographite, graphene flakes, carbon nanotubes, nanoclay, grinded roving, silica. The use of shuffling head in connection with the sonotrode enables a precise distribution of the refining additives and precise adding and fast mixing of highly reactive hardening agents even in powder and/or fluid e.g. with the use of multicomponent polymer matrix.

During the thermal treatment in the crosslinking stage used are: continuous ovens so called tunnel ovens based on the action of resistance heaters, halogen lamps and/or infrared, microwaves, electromagnetic induction field and/or non-continuous ovens i.e. work cycle based on the action of a closing heating lid; covering the laminate with heating panel and/or laying heating bars.

A further subject matter according to the invention is a device for the application of the reinforcement of the fibre polymer composite.

A device for making a layered composite laminate according to the invention is called shuffling head, comprising of: two external housing elements, two internal spacers, one or more shuffling elements and a spacer block with a hanger.

The device called the shuffling head is dedicated to the application of the polymer matrix on the surface of the treated element and/or on the fibre material that is interleaved by it and to the preparation of layered laminate of the composite reinforcement for laying on the surface of the treated element and/or on the place prepared for that. The shuffling head comprises of at least two, connected to each other with screws through straightway mounting openings, longitudinal external housing elements of a length dependent on the spacing and the number of the possessed shuffling elements with the allowance of a bed for seating the sonotrode. The shuffling head housing elements constitute the sliding construction of the device and these housing elements have: straightway opening at the initial part for mounting at a moveable joint. At least one housing element has inflow openings in a number equal to the number of the possessed shuffling elements. Between the housing elements internal spacers are located leading the shuffling head on the surface and/or on the dedicated place of the treated element. The inner spacers have, like the housing elements, straightway mounting openings, and their length is dependent on the spacing and the number of shuffling elements. At least one of the internal spacers has inflow openings in a number equal to the number of the possessed shuffling elements. Between the spacers one and/or more streamlined shuffling elements are located through tangential surfaces of which the fibre material is drawn. The shuffling elements are arranged lengthwise to each other serial and/or parallel having a shape of e.g. a ring of a smooth or coarse tangential surface and having on the flat side surface straightway mounting openings and an inflow opening in its central axis, where the polymer matrix is conveyed. The shuffling element has also an outflow opening—reaching the inside of the inflow opening—on its tangential plane at the lower part of the element from which the polymer matrix outflows on e.g. a fibre material. The shuffling head in the terminal part between the housing elements has a prepared place in the form of a bed for seating the sonotrode and at the end between the housing elements the device has a spacer block with a hanger and with straightway mounting openings.

All the straightway mounting openings of individual elements of the shuffling head are situated one to another coaxial-concentric. The inflow openings of the housing element and the internal spacer are, at least geometrically inscribed in individual inflow openings of the shuffling elements to enable mounting a port for a duct conveying the polymer matrix.

The inflow opening in the shuffling element is directed towards the fibre material and is situated on the tangential surface at an advantageous angle in respect of the horizontal axis of the shuffling head in a range from 0° to −135°. Such angle range enables directing the stream of the polymer matrix from direct pressing it into the fibre material to freely sprinkle the fibre material passing the shuffling element.

The streamline of the shuffling elements that their curvature radius at the place tangential with the fibre material should be bigger or equal to 16 mm e.g. 20 mm to prevent breaking and cracking of individual fibres when using brittle fibre materials.

The shuffling head is characterised by the modularity of the shuffling elements, that consists in subtraction and/or multiplication of the number of shuffling elements in a serial or parallel system enabling the adjustment of the width of the shuffling head, that in turn affect e.g. the thickness and/or height of the reinforcement through the number of layers of the fibre material interleaved on the surface of the treated element by the individual shuffling elements.

It is beneficial for the shuffling head to use the internal spacer and its protrusion under the level of the lower edge of the housing element in a range from 0% to 70% of the depth of the caved material, e.g. 8 mm. Through the protrusion of the inner spacer a guide rail over the treated element for the shuffling head is created and it has a beneficial influence on the insertion of the fibre material into the dedicated place or for the further guiding of the fibre material under the sonotrode.

As favourable results of the method according to the invention one has to indicate, that the process takes place in situ in a continuous method having a vast throughput power dependent on the adjusted feed speed of the drive and the pump output. The invention is dedicated for reinforcing constructional elements with a composite reinforcement based on fibre materials and polymer matrix. The beneficial results of the invention are provided by the shuffling head where the method of conveying and interleaving the fibre material and conveying the polymer matrix enables in a continuous process the creation of uniform or hybrid fibre reinforcement of constant and/or variable cross section using different kinds of fibre material and using any polymer matrix, whereupon the matrix may be conveyed in an uniform or hybrid form in a one-and/or multicomponent system. The manner and the place of conveying the polymer matrix enables using advanced polymer compositions and refining additives improving the mechanical-physical properties, as a result of that is the manufacturing of endurable matrices resistant against temperature, atmospheric, mechanical, physical, biotical and similar conditions.

The beneficial results of applying the device according to the invention is the possibility of applying layered composite laminate on the Surface and/or the place of the treated constructional element in a in situ process in a continuous method. The basic advantage of the invention is that thanks to the device the fibre material is simultaneously sandwiched, soaked with polymer matrix and laid on the surface and/or on the place of the processed element. The invention through shuffling elements enables to freely choose the fibre material composition and the manner of layered interleaving of the fibre material and the polymer matrix that in turn enables the creation of an uniform or hybrid composite reinforcement with the use of advanced polymer matrices in one-and/or multicomponent systems.

The method according to the invention uses primary raw materials, such as e.g. board and/or beam, fibre material and polymer matrix. The reinforcing process does not require a further specialised treatment (e.g. using autoclaves) resulting in vast energy saving. In the composite industry there is a pursuit for a manner of manufacturing composite in an out of autoclave method, i.e. pursuing a dedicated manufacturing of composite elements without using temperature-pressure autoclaves. The use of shuffling head in a process of laying the composite laminate and the ultrasonic sonotrode for pressing the reinforcement, mixing the components of the polymer matrix and its degassing to a significant degree replaces autoclavisation, as a result of that gives a fast and energy economical process of manufacturing a composite laminate. Moreover the use of the conveying-and-cutting apparatus and additional streaks of fibre material enables manufacturing composite laminate of constant and/or variable cross section and leads to the minimization of the consumption of fibre materials used in reinforcements of constructional elements especially large-scale.

### BRIEF DESCRIPTION OF THE SEVERAL VIEWS OF THE DRAWINGS

The invention is closer shown in the examples of realization and in the pictures.

FIG. 1 presents a schematic view of a diagram of the process of manufacturing of layered composite laminate with the use of ultrasounds in a continuous manner.

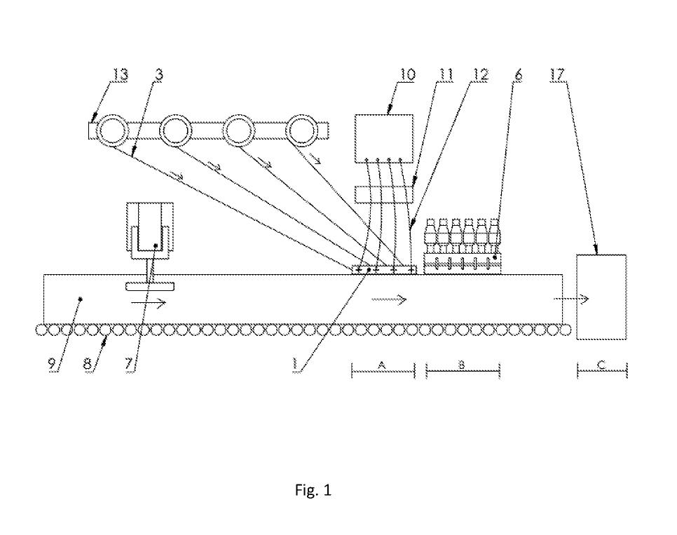

FIG. 2 presents a variant of the schematic view of the diagram of the process of manufacturing of layered composite laminate of a constant or variable cross section with the use of ultrasounds in a continuous manner.

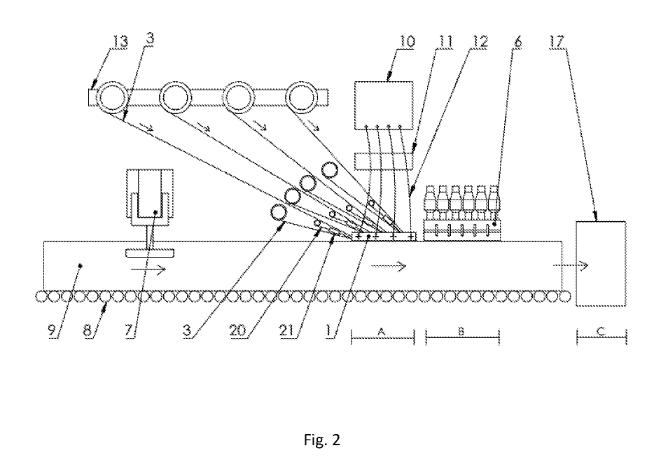

FIG. 3 presents a schematic view of the device for the application of the reinforcement of a fibre polymer composite with extraction disclosing the seating and the section of the shuffling element.

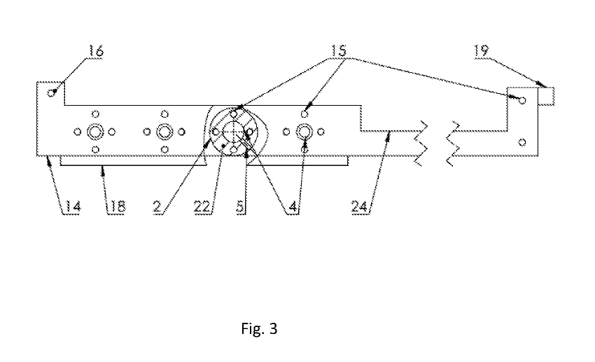

FIG. 4 presents a schematic view of the shuffling head (1) with the seated sonotrode in a bed of the housing of the shuffling head and an indication of the places of the sections.

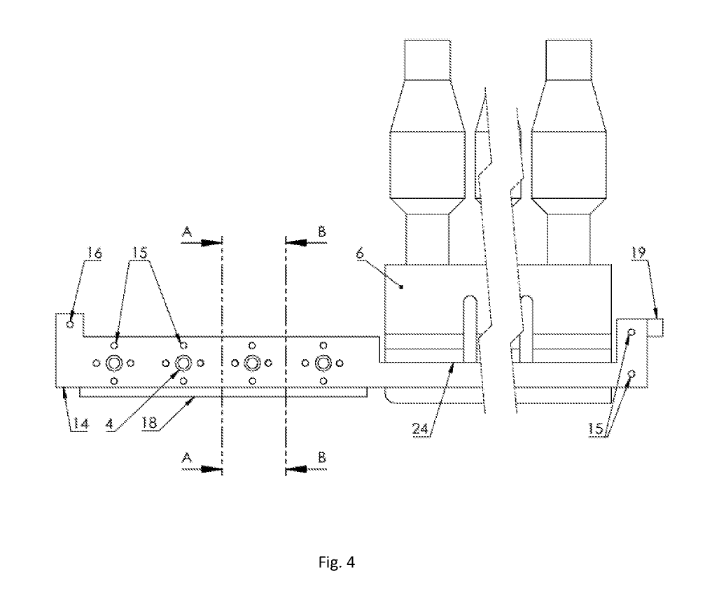

FIG. 5 presents the cross-sectional view of the line A-A of the subject presented in FIG. 4, where the section of the shuffling head (1) from the oncoming side and in the background the seating of the sonotrode is disclosed.

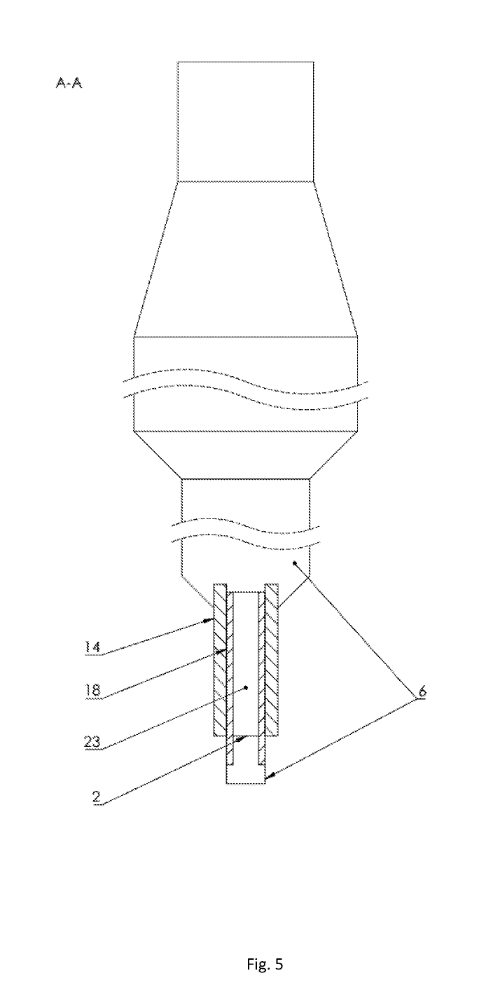

FIG. 6 presents the cross-sectional view of the line B-B of the subject presented in FIG. 4, where the section of the shuffling head (1) from the backside and the outflow opening is disclosed.

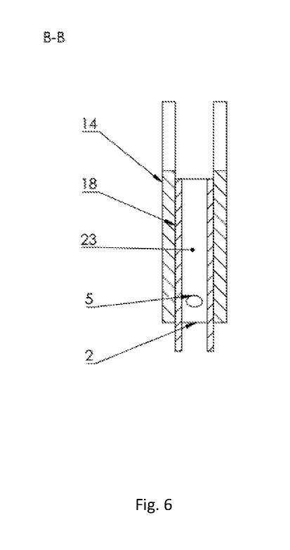

FIG. 7 presents the schematic view of the shuffling head's (1) from the backside and the manner of its seating in the treated constructional element.

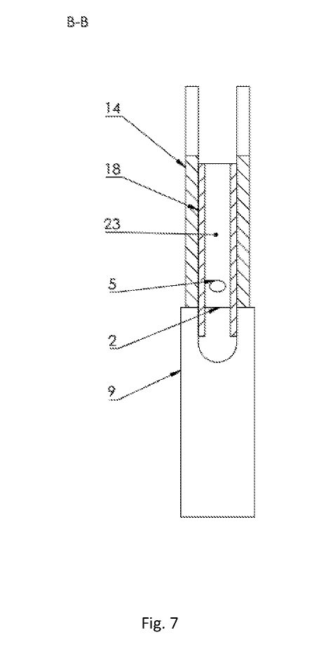

### DETAILED DESCRIPTION OF THE INVENTION

### Example 1

An example of a realization of the method of manufacture of a reinforcement of a fibre polymer composite in a prepared particle board of 22 mm thickness in a hybrid system with 4 basalt rovings and 2 carbon rovings, lengthwise distributed in an epoxy one-component system with grounding base, with the use of two-stage heating through a traditional work cycle oven.

The treated constructional element (9), the particle board of 22 mm thickness which underwent an earlier treatment by milling on its narrow surface in the axis with an e.g. U-shaped mill and a width of the mill 12 mm at a depth of 15 mm leaving the external edges of the board 5 mm thick, is fed to the guide rail rollers (8) and put into linear motion by a drive (7) of a feed speed of e.g. 6 m/m in.

Moreover when reinforcing thicker beams without milling, a translation of the boards with respect to each other alongside the edge, parallel of at least 3 pieces of boards making space for reinforcing while gluing the boards in the width. Next the treated constructional element (9) is moved by the drive (7) underneath the shuffling head (1) that is hanged on a machine frame on a moveable joint and positioned at a minimal incidence angle in relation to the moving constructional element (9). To the shuffling head (1) the fibre material (3) in the form of roving and in an amount of e.g. 30 g/m is conveyed from bobbin creel through each shuffling element (2) except for the first one, as it is dedicated for applying the first layer of grounding polymer matrix. In front of the second and the third shuffling element (2) basalt rovings (two for each shuffling element) are drawn and in front of the fourth shuffling element (2) two carbon rovings are drawn. To each shuffling element (2) through the inflow opening (4) the polymer matrix from a container (10) via ducts (12) by means of a multistream pump (11) of a general output of 30 g/m and an additional 10% for the grounding layer is conveyed. The container (10) has a mixing and heating e.g. to 50° C. function for simplifying pumping and for a better distribution of the polymer matrix. The polymer matrix is a ready mixture and contains e.g. three components in the following proportions, where for 100 g of polymer composition accrues: 60 g of epoxy resin Bisphenol A, 48 g of hardening agent acid anhydrate MTHPA, 0.6 g imidazole accelerating agent. The soaked with polymer matrix and laid in the place of reinforcing the particle board fibres of hybrid composition come under the sonotrode (6) which is seated in the bed of the shuffling head's (1) housing elements behind the shuffling elements (2). The sonotrode (6) of an exemplary power of 11 W/cm² and a frequency of e.g. 20 kHz under the influence of ultrasonic vibrations acts on the polymer matrix, which is precisely mixed and distributed between the roving fibres. The composite reinforcement is submitted to sonication by an average of 4-5 sec. During the sonication of the given exemplary parameters under the influence of the sonotrode's (6) own mass pressing of the composite reinforcement and degassing of the polymer matrix occurs. Next for hardening the composite, the reinforced particle board is inserted into the oven where it is gradually heated e.g. for 2 hrs at a temp, of 85° C. and for 4 h at a temp, of 110° C.

### Example 2

An example of a realization of the method of manufacture of a reinforcement of a fibre polymer composite of a variable cross section in a prepared particle board of 22 mm thickness in a hybrid system with 4 basalt rovings, 2 additional basalt rovings and 2 carbon rovings, lengthwise distributed in an epoxy one-component system with grounding base, with the use of two-stage heating through a traditional work cycle oven.

The treated constructional element (9), the particle board of 22 mm thickness which underwent an earlier treatment by milling on its narrow surface in the axis with an e.g. U-shaped mill and a width of the mill 12 mm at a depth of 15 mm leaving the external edges of the board 5 mm thick, is fed to the guide rail rollers (8) and put into linear motion by a drive (7) of a feed speed of e.g. 6 m/min.

Moreover when reinforcing thicker beams without milling, a translation of the boards with respect to each other alongside the edge, parallel of at least 3 pieces of boards making space for reinforcing while gluing the boards in the width. Next the treated constructional element (9) is moved by the drive (7) underneath the shuffling head (1) that is hanged on a machine frame on a moveable joint and positioned at a minimal incidence angle in relation to the moving constructional element (9). To the shuffling head (1) the fibre material (3) in the form of roving and in an amount of e.g. 30 g/m is conveyed from bobbin creel through each shuffling element (2) except for the first one, as it is dedicated for applying the first layer of grounding polymer matrix. In front of the second and the third shuffling element (2) basalt rovings (two for each shuffling element), as a fibre material (3), are drawn, between them by means of a conveying-and-cutting apparatus (21) additional streaks of basalt roving are conveyed, as an additional fibre material (20); in front of the fourth shuffling element (2) two carbon rovings are drawn, as a fibre material (3). To each shuffling element (2) through the inflow opening (4) the polymer matrix from a container (10) via ducts (12) by means of a multistream pump (11) of a general output of 30 g/m and an additional 10% for the grounding layer is conveyed. The container (10) has a mixing and heating e.g. to 50° C. function for simplifying pumping and for a better distribution of the polymer matrix. The polymer matrix is a ready mixture and contains e.g. three components in the following proportions, where for 100 g of polymer composition accrues: 60 g of epoxy resin Bisphenol A, 48 g of hardening agent acid anhydrate MTHPA, 0.6 g imidazole accelerating agent. The soaked with polymer matrix and laid in the place of reinforcing the particle board fibres of hybrid composition come under the sonotrode (6) which is seated in the bed of the shuffling head's (1) housing elements behind the shuffling elements (2). The sonotrode (6) of an exemplary power of 11 W/cm² and a frequency of e.g. 20 kHz under the influence of ultrasonic vibrations acts on the polymer matrix, which is precisely mixed and distributed between the roving fibres. The composite reinforcement is submitted to sonication by an average of 4-5 sec. During the sonication of the given exemplary parameters under the influence of the sonotrode's (6) own mass pressing of the composite reinforcement and degassing of the polymer matrix occurs. Next for hardening the composite, the reinforced particle board is inserted into the oven where it is gradually heated e.g. for 2 hrs at a temp, of 85° C. and for 4 h at a temp, of 110° C.

Example 3

A device for an application of a reinforcement of a fibre polymer composite in a given configuration with 4 shuffling elements for a particle board of 22 mm thickness with a milled U-shape groove in its axis on the narrow surface of 12 mm width and at a depth of 15 mm.

The dimensions of the shuffling head (1) are dependent on the width and the depth of the material caved from the particle board by a mill. The construction of the shuffling head (1) in the described example comprises the elements: four shuffling elements (2) with a shape of e.g. a ring 8 mm thick and an external radius of e.g. 45 mm located in the axis of the shuffling head (1) and at a distance of e.g. 30 mm from each other. Each shuffling element (2) has: four mounting openings (15) located on the flat side surface (22) distributed symmetrically and providing a tight clamp, one inflow opening (4) located on the flat side surface (22) in the central part of the element, to the interior of the inflow opening the polymer matrix is conveyed via a duct (12) and one outflow opening (5) located on the tangential surface (23) of the element, reaching the interior If the element, located in the lower part of the element at an angle of e.g. −45° in relation to the horizontal axis directed towards the drawn fibre material (3), through the outflow opening the polymer matrix is led out. The shuffling head (1) is mounted on a moveable joint by means of openings (16) in the initial part of the housing. The shuffling head (1) has two external housing elements (14) e.g. 4 mm thick and 45 mm high at the side of the flat side surfaces (22) of the shuffling elements (2), which (i.e. the housing elements) as a result of locating the shuffling head (1) at a minimal incidence angle in relation to the moving constructional element (9), are sliding under the external edges of the particle board, lifting the shuffling head (1) and levelling it in relation to the edges of the particle board.

The housing elements (14) in the terminal part have a prepared place in the form of a bed (24), in which the sonotrode is seated (6). The shuffling head (1) has two internal spacers (18) 2 mm thick and 54 mm high situated between the shuffling element (2) and the housing element (14) in such a manner that the protruding lower part is led in the space left after the caved material of the particle board, sliding at the internal surfaces of the particle board's external edges, making simultaneously a shield for the conveyed fibre material (3) and a guide rail for the shuffling head (1). The internal spacers (18) have the same length as the length on which the shuffling elements (2) are distributed, e.g. 270 mm, whereupon the length of the housing elements (14) is elongated by the bed (4) at a length of the sonotrode (6) with a preservation of a small play (clearance) e.g. 10 mm. The housing elements (14) and the internal spacers (18) comprise straightway mounting openings (15) situated concentrically in relation to the mounting openings of the shuffling elements (2) and one housing element (14) and one internal spacer (18) entail straightway inflow openings (4) situated concentrically in relation to the inflow openings (4) of the shuffling elements (2). Between the housing elements (14) at the end of the device there is a spacer block with a hanger (19) 12 mm thick, which enables a save seating of the shuffling head (1) on the frame of the machine when there is a lack of a treated constructional element (9) under the shuffling head (1).

A method for manufacturing of a layered composite laminate by the use of ultrasounds in a continuous method, finding its application in industrial reinforcing large-scale constructional elements intended mainly for the construction industry. Examples of such elements are roof beams and roof rafters intended for light building constructions in civil as well as industrial construction industry and in the constructions of industrial buildings. The invention can also be applied in the manufacturing of supporting (load-bearing) bridge constructions, small and big, and footbridges. The invention will be also applied in boards connected in layers, e.g. in all kinds of ply reinforced with composite fabrics and all elements of synthetic materials based on fibre polymer composites, the manufacturing of which takes place linearly in a continuous or work cycle process.

1. A method of manufacturing layered composite laminate for use as reinforcement of constructional elements,
wherein an application of the layered composite laminate on a surface and/or a place of the treated constructional element happens in-situ in a continuous process with a use of ultrasounds,
wherein an initially prepared constructional element is put in a feed motion, the method of manufacturing of layered composite laminate comprising the steps of:
a) shuffling stage, wherein a shuffling head in front of at least one shuffling element, simultaneously fibre materials being roving materials and/or additional fibre materials are conveyed from bobbin creels and to the interior of each shuffling element via inflow opening, wherein a polymer matrix is conveyed through ducts in a one-, two- or multicomponent system from a container by a pump of a total output in weight relation to the fibre material from 0.8:1 to 1.2:1, and wherein, as a result of shoving the constructional element, the fibre material is sandwiched and simultaneously soaked with polymer matrix, passing through the shuffling head that is sliding over the constructional element the fibre material being laid on the surface and/or in the place of the constructional element;
b) sonication stage, wherein a sonotrode of a width of at least equal to the width of the applied laminate and of a power from 5 to 500 W/cm² presses and mixes of all the components of polymer matrix taking place in a time from 2 to 10 sec, through sliding of the sonotrode at the place of the earlier layered laid fibre material soaked with polymer matrix on the constructional element; and
c) crosslinking stage during which the layered laid fibre material soaked with polymer matrix and being on the constructional element after the sonication stage is submitted to thermal treatment of hardening in an oven, in a temperature range from 50 to 180° C.; to the moment of reaching the desired level of hardening and maximum thermal resistance from 2 to 6 hrs.

2. A The method according to claim 1, wherein the constructional elements are comprised of beams, glulam, wood-base boards, boards from wood or synthetic materials, lignocellulosic boards initially prepared through caving of the material.

3. The method according to claim 1, wherein the multi-layered composite laminate is a hybrid system, being comprised of fibre materials conveyed to the shuffling head from the bobbin creel, wherein the fibre materials are used in the form of roving or roving-fabrics from natural, cellulosic and/or synthetic fibres, and wherein the roving fabrics appear in an one-, two- or multidirectional system.

4. The method according to claim 1, wherein additionally through the shuffling elements, at least two streaks of fibre material are interleaved, making up a convergent angle in that through a conveying-and-cutting apparatus an additional fibre material in the form of continuous roving and/or in sections is inserted and subsequently grabbed, and wherein the obtained layered composite laminate has a constant and/or variable cross section.

5. The method according to claim 1, wherein the shuffling stage and sonication stage occur one and/or many times and the crosslinking stage is always the last one.

6. The method, according to claim 1, wherein the polymer matrix contains additives and/or fillers in micro- or nanoscale in the form of powders and/or suspensions refining the polymer matrix such as nanographite, graphene flakes, carbon nanotubes, nanoclay, grinded roving.

7. The method according to claim 1, wherein, at the crosslinking stage during the thermal treatment continuous ovens, non-continuous ovens, covering the laminate with heating panel and/or laying heating bars is used.

8. The device for application of polymer matrix on fibre material and preparation of layered laminate and/or composite reinforcement for laying on the surface of a treated constructional element and/or in a place prepared for that, the device comprising:
at least two longitudinal, external housing elements connected to each other with screws through straightway mounting openings, the length of the housing elements being dependant on the spacing and the number of shuffling elements with the allowance of a bed at the length of a sonotrode comprising the sliding construction of the shuffling head and these housing elements have: straightway mounting openings, at the initial part an opening for mounting at a moveable joint, whereupon at least one housing element has inflow openings in a number equal to the number of the shuffling elements;
between the housing elements internal spacers are located leading the head and having straightway mounting openings of a length dependent on the spacing and the number of shuffling elements, whereupon at least one of the spacers has inflow openings in a number equal to the number of shuffling elements;
between the spacers one and/or more streamlined shuffling elements are located through tangential surfaces of which the fibre material is drawn, the shuffling elements are arranged lengthwise to each other serial and/or parallel having on the flat side surface straightway mounting openings and an inflow opening in its central axis, where the polymer matrix is conveyed and an—reaching the inside of the inflow opening—outflow opening on the tangential plane at the lower part of the element, where the polymer matrix outflows on the fibre material; and
the shuffling head in the terminal part between the housing elements has a spacer block with a hanger and with straightway mounting openings.

9. The device according to claim 8, wherein straightway mounting openings of individual elements of the shuffling head are situated one to another coaxial-concentric, and wherein the inflow openings of the housing element and the internal spacers are, at least geometrically inscribed in individual inflow openings of the shuffling elements.

10. The device according to claim 8, wherein the inflow opening in the shuffling element is directed towards the fibre material and is situated on the tangential surface at an angle in respect of the horizontal axis of the shuffling head in a range from 0° to −135°.

11. The device according to claim 8, wherein curvature radius of the shuffling element in the place tangential with the fibre material is bigger or equal to 16 mm.

12. The device according to claim 8, wherein, through subtraction or multiplication of the number of shuffling elements in a serial and/or parallel system the adjustment of the width of the shuffling head takes place.

13. The device according to claim 8, wherein the internal spacer is protruding under the level of the lower edge of the housing element in a range from 0% to 70% of the depth of the caved material, favourably by 8 mm.
